(19) United States
(12) Patent Application Publication
(10) Pub. No.: US 2008/0173838 A1
(43) Pub. Date: Jul. 24, 2008

(54) Actuator

(75) Inventors: Markus SCHMIDIG, Ibach (CH); Eduard MARTHALER, Adetswill (CH)

Correspondence Address: THADDIUS J. CARVIS, 102 NORTH KING STREET, LEESBURG, VA, 20176, US

(73) Assignee: BELIMO HOLDING AG, Hinwil (CH)

(21) Appl. No.: 12/013,772

(22) Filed: Jan. 14, 2008

(30) Foreign Application Priority Data
Jul. 14, 2005 (CH) 1168/05
Jun. 12, 2006 (CH) PCT/CH2006/000314

(51) Int. Cl. F16K 31/02

(52) U.S. Cl. 251/129.11

(57) ABSTRACT

An actuator (10) and adapter (16,116), in particular with an electric motor (60), and a highly reduced gearing (48), is used for transmitting a torque to a continuous drive shaft (24) of at least one flap or at least one valve to control a gas or liquid volume flow. The adapter (16,116) which is used in particular in the sector of heating/ventilation/air-conditioning (HVAC), fire and space protection can be fitted in a manner which is locked against rotation in the radial direction to a frame or support of the actuated member. With the drive shaft (24,124) it forms a releasable frictional and/or positive connection. The actuator is preferably actuated by an electric actuator motor but also pneumatically, hydraulically or manually. The actuator (10) and adapter (16,116) can optionally be used as a bridging drive.

The invention relates to an actuator, in particular with an electric motor and a highly reduced gearing for transmitting a torque to a drive shaft of at least one flap or at least one valve for controlling a gas or fluid volume flow, in particular in the sector heating/ventilation/air-conditioning (HVAC), fire and space protection. The invention also relates to a use for the actuator.

Electrically actuable actuators for the motorization of actuators in heating, ventilation and climatisation systems (HVAC systems) have been produced for more than 30 years. HVAC actuators ensure an economical volume flow control of gases or liquids, in particular air and water. As a compact unit, the HVAC actuators generally comprise not only the drive, but also pressure sensors and controllers, all combined in one apparatus.

Ventilation systems are increasingly used in buildings, in particular residential, office, commercial and industrial buildings, generally combined with fire and smoke protection devices. The volume flow control with pivotable air flaps plays an important part in ventilation systems. The volume flow is measured with a suitable measuring instrument, for example with the NMV-D2M configured as a compact unit of drive, pressure sensor and controller from Belimo Automation AG, CH-8340 Hinwil, and the measured values are relayed to electronics.

To actuate a flap in a ventilation system or to actuate a ball valve in a water pipeline system, comparatively weak motors have to actuate large-area or large-volume control members. Precise and stable adjustment is only possible with a very high gear reduction. To pivot a flap or rotate a ball valve about an acute to right angle, numerous revolutions of the primary shaft of the electric motor are necessary. The reduced torque of the motor is converted into a pivoting or linear movement in an actuator.

An actuator for the linear actuation of a device is described in WO 2006/024183, and actuates a longitudinally displaceable tangential rod with the conversion of the torque of a pinion driven by an electric motor. Said tangential rod in turn actuates a flap or a valve in the sector HVAC, fire and smoke protection. An individually controllable standard threaded rod, which can be displaced in its axial direction, is held in a manner which is locked against rotation in the actuator. The pinion is in positive engagement with at least one freely rotatable drive wheel. A resilient pressure member produces play-free meshing of drive wheels and standard threaded rods.

The patent U.S. Pat. No. 7,025,328 (Johnson Controls Technology Co.) describes a side mount damper actuator having a torque transfer mechanism which is coupled between an actuator hub and a damper shaft-attachable external clamp such that rotation of the hub results in a rotation of the damper shaft. The coupling of the external clamp to the hub involves meshing toothed wheels which are attached to the housing of the actuator. The actuator of the U.S. Pat. No. 7,025,328, however, has to be configured to be able to shift as the damper shaft is rotated by the torque transfer mechanism to compensate for eccentric rotation of the offset clamp with respect to the damper shaft. Moreover, the toothed wheels of the torque transfer mechanism are mounted outside of the actuator housing and are therefore pollution- and interference-prone, in particular in in-duct mounting configurations.

It is an object of the invention to provide an actuator of the type mentioned at the outset, which simplifies the actuation of the drive shaft. It is a further object to simplify the way of mounting the actuator. Finally it is desirable that the actuator or adaptable may be used even for the retrofitting of existing plants.

The object is achieved according to the invention in that the actuator can be fitted in a manner which is locked against rotation in the radial direction directly or by way of an adapter to a frame or support of the actuated member and, with a continuous drive shaft, forms a releasable frictional and/or positive connection. Special and developing embodiments of the actuator are the subject of dependent claims.

The drive shaft may be relatively short and actuate a single control member, such as a flap or a valve. The drive shaft may, however, also be longer and simultaneously actuate a plurality of control members. A continuous drive shaft does not have to be separated to fit an actuator. A long drive shaft can also be actuated with a single control member. To replace an actuator, the fastening screws and the frictional and/or positive connection at the drive shaft merely have to be released. The new actuator to be used does not have to be fitted at the same point as the one which is to be repaired or replaced and thus the replacement can take place practically without interrupting operation and only a few seconds are required.

As shown below in detail, for refitting or retrofitting, an adapter is preferably fastened to a base plate, which expediently also holds the actuator in a manner which is locked against rotation.

The lateral connection takes place by means of a U-shaped or semi-circular slot provided at the end face on the actuator or on the adapter, into which slot the drive shaft fits with little play. The reaction force of the actuator is absorbed by the joint base plate or the extension thereof.

The frictional and/or positive connection between the drive shaft of the actuator or the adapter on the one hand, and the drive shaft on the other hand, takes place in a manner which is known per se, for example by way of
a clamp, preferably with transverse flutes for a positive connection,
two end toothed wheels or toothed wheel segments engaging in one another in a positive manner, or
a gearing hollow shaft, which is semi-circular in cross-section, with internal teeth, which, after radial insertion and fixing of the actuator or the adapter, are in positive engagement with external teeth of the drive shaft.

The actuator or the adapter is generally fixed to a frame or support of the HVAC system by screwing to form the frictional and/or positive connection with the drive shaft. This has to take place in a manner which is locked against rotation and the reaction force of the drive has to be absorbed. At least two positions where an actuator, with or without an adapter, can be screwed, are expediently provided in the region of each drive shaft. According to a special embodiment of this invention, the actuator can also be plugged onto a snap-on device and is immediately ready to operate. This actuator can above all be plugged on in the event of an operating failure of a drive motor and be put into operation without delay. When the actuator and the adapter are arranged on a common base plate, only the latter has to be fastened or snapped on.

An adapter in the form of a parallelogram has proven particularly advantageous, a gearing yoke and a drive yoke being connected in an articulated manner by way of parallel connecting bars. The torque to be applied is transmitted to the gearing yoke by way of a gearing output shaft and relayed from there by way of the connecting rods to the drive yoke, which passes the torque with a frictional and/or positive connection to the drive shaft. In this case, neither the drive nor the attachment needs a bearing.

The actuator according to the invention can be used anywhere where an actuator of this type is required. The control members, in particular flaps or valves, are driven individually or in groups by a joint continuous drive shaft.

The lateral connection of an actuator may take place at each location of an individual or joint drive shaft where the actuator can be connected to the frame or to a support of the HVAC system

A particular form of use of the actuator according to the invention consists in floating use. If a motor of an actuator fails somewhere, a complete actuator can be screwed on or inserted and fixed with a snap-on mechanism in the radial direction at another point of the drive shaft.

The actuator according to the invention, which can be fixed in the radial direction, can be fitted more simply and quickly at any point or a predetermined point on the continuous drive shaft and has greater flexibility with regard to positioning. Actuators of existing systems can be retrofitted by the installation of an adapter. The actuator is actuated, in particular by a motor. The use of an electric motor, expediently an actuator motor is preferred. In certain cases, pneumatic or hydraulic drive motors may serve the purpose. A manual drive is also not ruled out.

Preferably the adapter for transmitting a torque from a separate actuator to a drive shaft of at least one flap or at least one valve for controlling a gas or fluid volume flow, in particular in the sector of heating/ventilation/air-conditioning (HVAC), fire and area protection fulfills the following conditions:
the adapter is configured to be fitted to a continuous drive shaft in a direction which is radially oriented with respect to the drive shaft,
the adapter is further configured to form a releasable frictional and/or positive connection to said drive shaft and
the adapter is configured to be mounted on a frame or support of the actuated member in a manner which is locked against rotation.

The adapter has preferably on at least one end an insertion slot for the drive shaft, which slot is substantially U-shaped or semicircular.

The adapter may comprise a removable bearing insert arranged in the insertion slot forming a bearing seat for the drive shaft.

The adapter preferably comprises a torque transfer mechanism in form of a linkage parallelogram which is fitted to a base plate and comprises a gearing yoke which can be actuated by the actuator, a drive yoke for the drive shaft and two parallel connecting rods connected in an articulated manner to the ends of the two yokes, the gearing yoke being connected to a gearing shaft and the drive yoke to the drive shaft in a frictional and/or positive manner.

The bearing insert may forms a bearing seat for the drive yoke.

A method for mounting an actuator comprising the steps of
mounting the adapter to a drive shaft;
securing the adapter to a frame or support structure of the actuated member;
attaching the actuator to the adapter;
connecting the actuator to electricity/control units etc.;
wherein the adapter serves as a mounting bracket for the actuator
and the adapter is fixedly locked against rotation.

The invention will be described in more detail below with the aid of embodiments which are shown in the drawings and are also the subject of dependent claims. In the drawings, schematically:

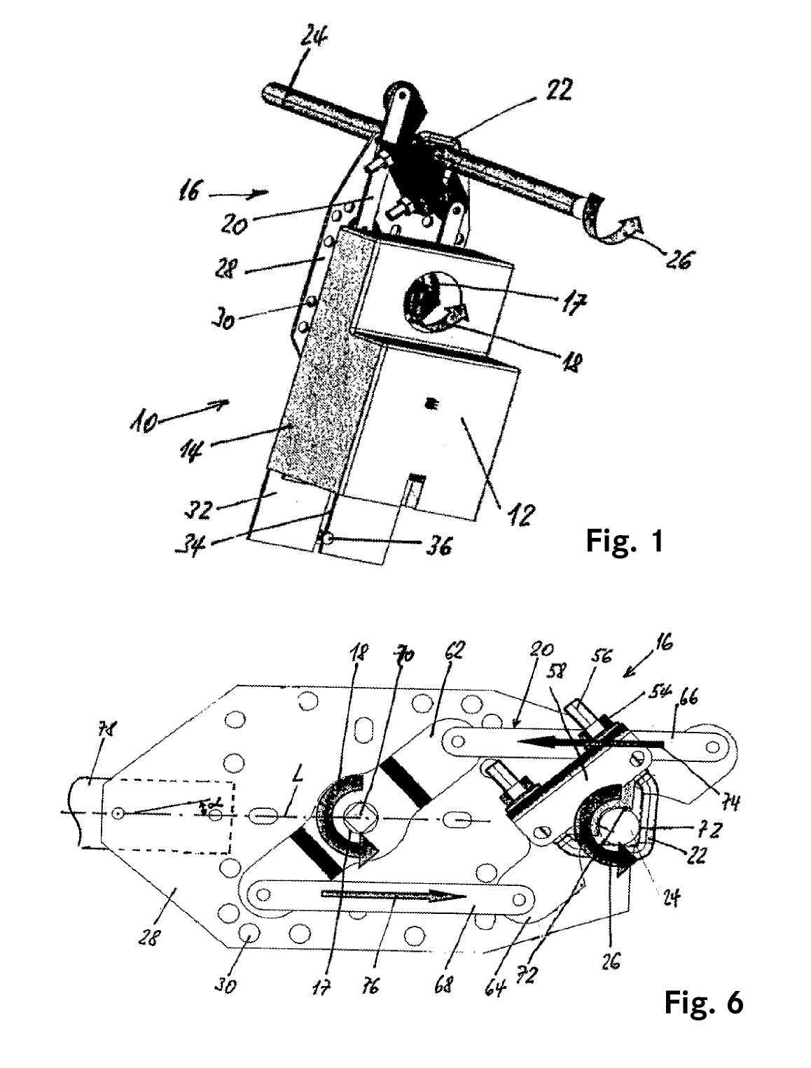

FIG. 1 shows a perspective view of an actuator with a partially visible adapter,

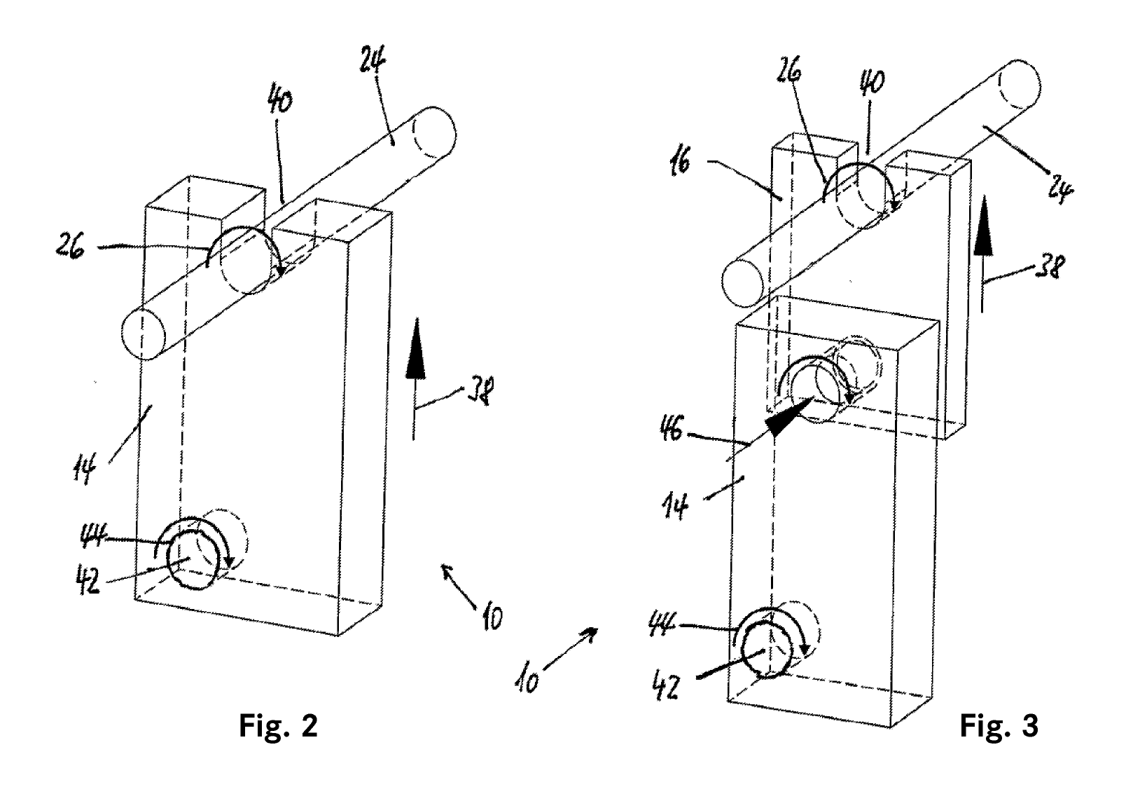

FIG. 2 shows a perspective view of an actuator,

FIG. 3 shows a perspective view of an actuator with an adapter,

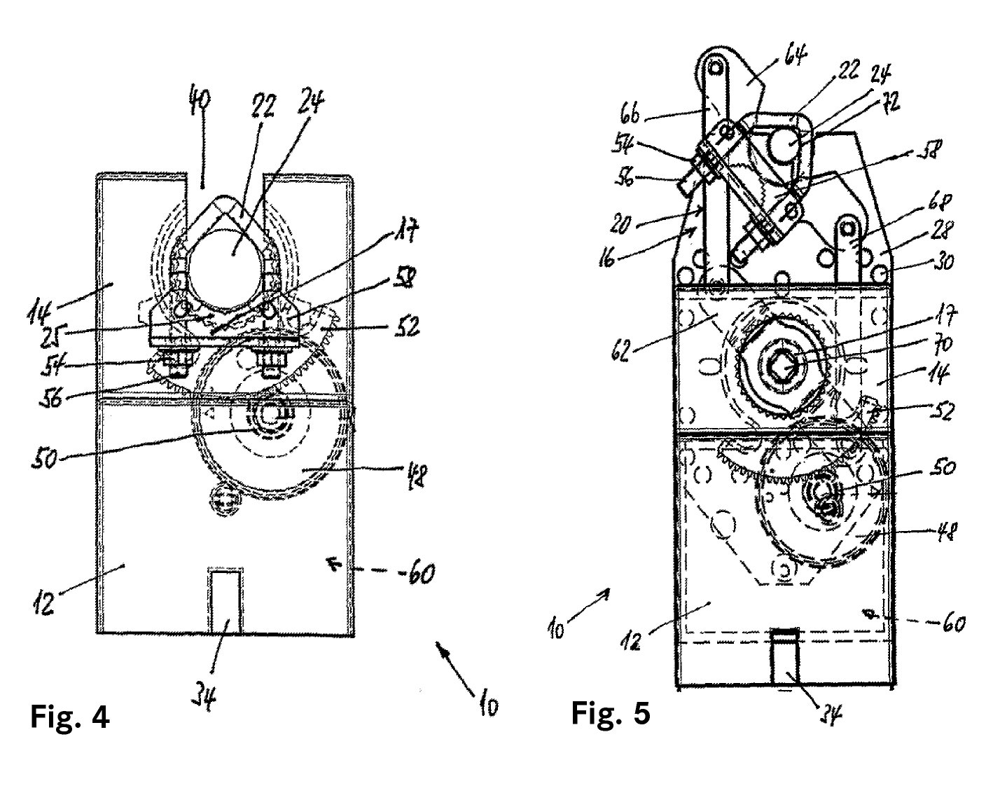

FIG. 4 shows a cut open view of an actuator,

FIG. 5 shows a cut open view of an actuator with an adapter, and

FIG. 6 shows a conversion mechanism of an adapter with a parallelogram,

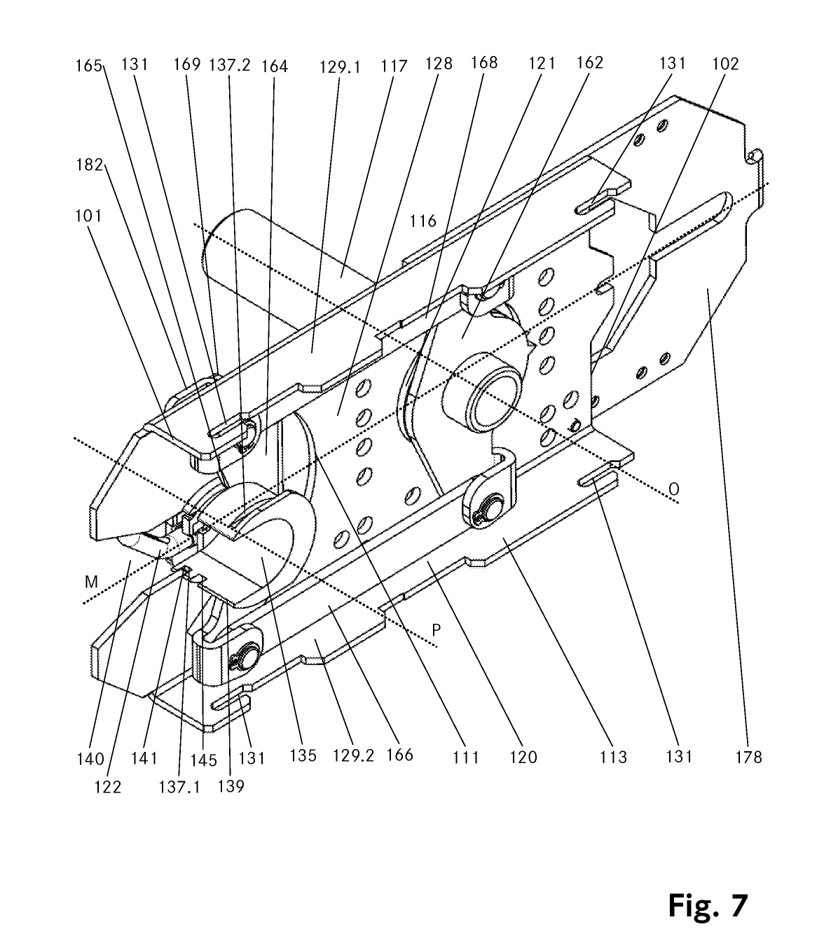

FIG. 7 shows a perspective view of another embodiment of an adapter with housing,

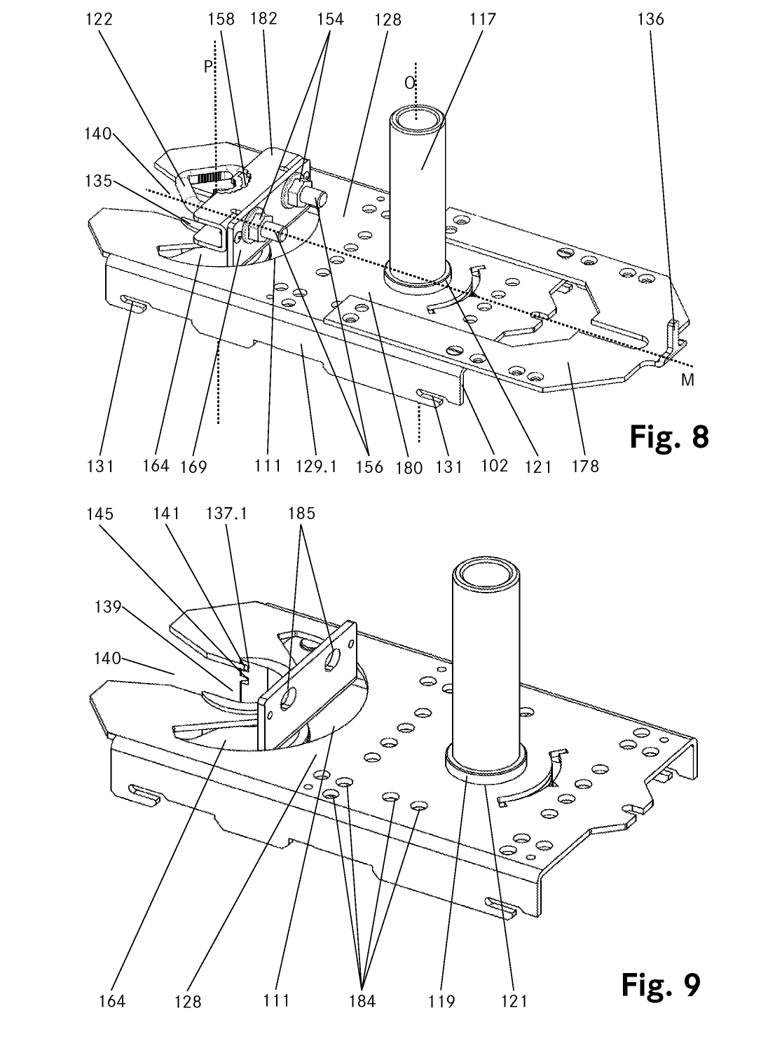

FIG. 8 shows an outside perspective view of the adapter of FIG. 7,

FIG. 9 shows the perspective view of FIG. 8 with some outside parts removed for better visibility of otherwise hidden parts,

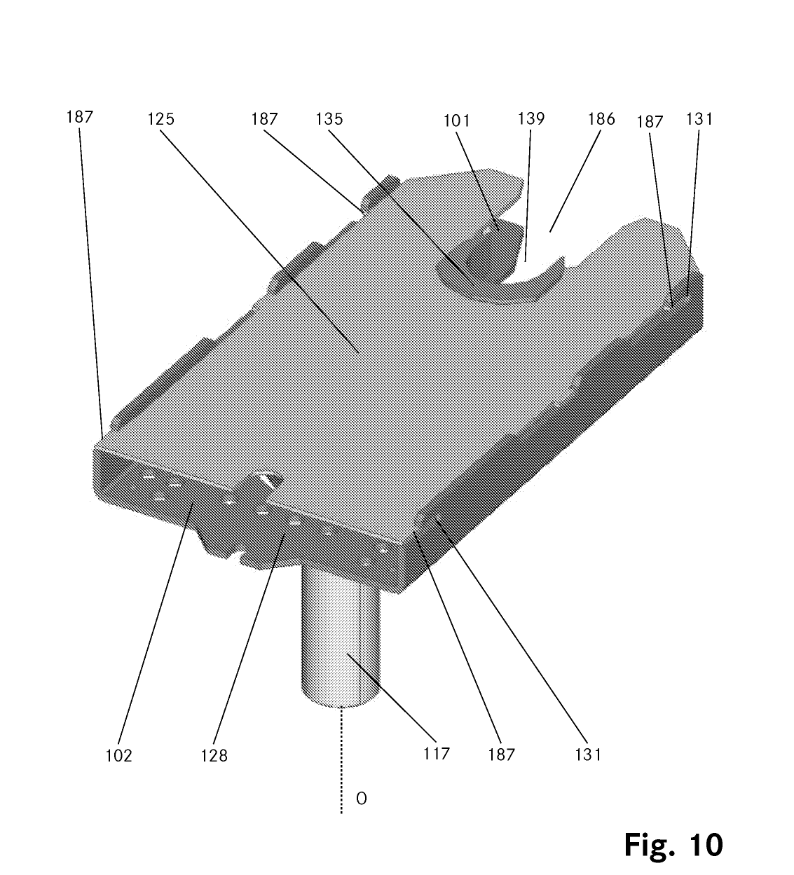

FIG. 10 shows a perspective view of the adapter of FIGS. 7 to 9 with attached back plate.

An actuator 10 shown in FIG. 1 substantially comprises a motor housing 12 and a gearing housing 14, which are arranged in a joint housing. The reduction gearing reduces several hundred revolutions of the primary shaft of the electric motor to a fraction of a revolution of the gearing output shaft 17, and this is indicated by an arrow 18. This pivotal movement is transmitted by the adapter 16, which is substantially configured as a parallelogram 20, with a clamp 22, to a continuous drive shaft 24, which triggers the opening and closing of flaps or valves owing to the adopted pivotal movements. This pivotal movement is characterized by an arrow 26, which extends in the same direction of rotation as arrow 18.

The adapter 16 substantially comprising a parallelogram 20 is pivotably held on a base plate 28, which can be screwed in turn by way of fitting holes 30 to a frame or support of the actuated member.

The actuator 10 is also screwed to the base plate 28 of the adapter 16 or to an extension (78 in FIG. 6) thereof. The base plate of the actuator 10 has an extension 32 with a longitudinal central slot 34. A bolt 36 of the extension, not shown, of the base plate 28 is guided in this slot 34. The actuator 10 is thus attached in a manner which is locked against rotation. The reaction force of the drive is received under favourable lever conditions.

FIG. 2 shows the gearing housing 14 of an actuator 10 (FIG. 1), which is plugged in the direction of the arrow 38 in the radial direction onto a continuous drive shaft 24 and is fixed in a manner which is locked against rotation with means which are not shown. The gearing housing 14 has a U-shaped slot 40 at the end face, in which the drive shaft 24 fits with little play. The U-shaped slot 40 can be reduced to a semi-cylindrical opening. The direction of rotation of the drive shaft 24 is shown by an arrow 26.

The means for frictional or positive transmission of the torque of the gearing output shaft 17 (FIG. 1) to the drive shaft 24 are not shown for the sake of simplicity. In the present case, said drive shaft has external teeth at least in the region of the reduction gearing. When plugging on and fixing the reduction gearing 14, the external teeth of the gearing output shaft 17 engage in a positive manner in the external teeth of the drive shaft 24.

An opening 42 for the primary shaft of the actuator motor 10 (FIG. 1) is provided in the lower region of the gearing housing 14. This primary shaft also has external teeth, which are in positive engagement with a toothed wheel of the reduction gearing after the insertion of the actuator motor 60. The drive by means of a primary shaft of the actuator motor 60 is characterized by an arrow 44.

According to the embodiment of FIG. 3, the gearing housing 14 with the gearing output shaft 17 is plugged onto an adapter 1 6. This takes place in the direction of the arrow 46, which extends parallel to the drive shaft 24. The U-shaped slot 40 for plugging onto the drive shaft 24 in the radial direction is attached in the adapter 16 on the end face. The adapter 16 transmits the torque for the reduction gearing, to be exerted on the drive shaft 24, and a U-shaped slot 40 is no longer necessary in the gearing housing 14. Owing to the adapter 16 installed actuators 10 can also be retrofitted, without complicated mechanical processing methods being necessary.

FIGS. 4 and 5 substantially show the interior of FIGS. 2 and 3. For the sake of clarity, nothing is drawn in the motor housing 12 in FIG. 4, the construction of which corresponds to a conventional actuator motor 60. Part of the reduction gearing 48 can be seen in the gearing housing 14. A pinion 50, the external teeth of which engage in a tooth segment 52 with a substantially larger radius, is arranged on a gearing shaft. This tooth segment 52 has a relatively small pivotal range of slightly over 90°. It actuates the gearing output shaft 17, which is in frictional and positive engagement by way of a clamp 22 with the drive shaft 24 for the control members.

The screws 54 bringing about the clamping effect on the legs 56 of the clamp 22 are adjustably braced against a shoulder 58 of the tooth segment 52, or an intermediate piece.

FIG. 5 shows an adapter according to FIG. 3, which substantially consists of a parallelogram 20. This parallelogram 20 extends in the longitudinal direction of the base plate 28 and consists of a gearing yoke 62, a drive yoke 64 and two connecting rods 66, 68 connecting the two yokes in an articulated manner.

The gearing yoke 62 is rotatably connected to the base plate 28 and rigidly connected to a polygonal shaft 70, which extends perpendicularly to the base plate 28.

In the present case, the shaft 70 is square in cross-section, but it may also have another, but not circular, cross-section, for example triangular, hexagonal or circular with a flattened area. The shaft 70 is plugged into the gearing output shaft 17 with a corresponding cavity to form a positive connection.

The drive yoke 64 has, longitudinally centrally, towards the outside, a part-circular recess, which approximately corresponds to the U-shaped slot 40 in the base plate 28. Furthermore, a lug of the drive yoke 64 is bent twice approximately at right angles and thus forms a shoulder 58 for fastening the clamp 22. The legs 56 of the clamp 22 have an external thread and two screw nuts 54 with plain washers tighten the clamp onto the inserted drive shaft and form a frictional connection.

FIG. 6 shows an adapter 16, substantially a parallelogram 20, fitted on a base plate 28, with a clamp 22 acting with a frictional and positive connection on a drive shaft 24. The gearing output shaft 17 transmits a torque to the shaft 70, which is square in cross-section and in turn forms a positive connection to the gearing yoke 62 of the parallelogram 20. The rotary movement which is characterized by the arrow 18 is transmitted by two parallel connecting rods 66, 68 which are connected in an articulated manner to the gearing yoke 62, to the drive yoke 64. The clamp 22 is screwed to a shoulder 58 which is bent twice at right angles and configured in one piece with the drive yoke 64 and the two legs 56 with an external thread can be tensioned by way of screw nuts 54. The clamp 22 is thereby pressed onto the drive shaft 24 and forms a frictional connection. Transverse flutes 72 on the clamp 22 in the recess in the drive yoke 64 and in a recess of the shoulder 58, in addition to the frictional connection, also allow an at least partial positive connection.

If the gearing yoke 62 and the drive yoke 64 move in the direction of the arrows 18, 26, the two connecting rods 66, 68 carry out a parallel movement in the opposite direction characterized by the arrows 74, 76, to the partially drawn in longitudinal axis L of the base plate. The axis of the drive shaft 24 intersects the longitudinal axis L. According to embodiments which are not shown, the base plate 28 may be fitted in such a way that the drive shaft 24 is located outside the longitudinal axis L. The connecting rods 66, 68 then run at an angle α to the longitudinal axis L, wherein the angle α may be up to ±90° or more.

An only partially shown extension 78 of the base plate 28 allows an additional fastening of the gearing housing 14 (FIG. 1 to 3) for better absorption of the reaction force of the torque which is exerted on the drive shaft 24 and the actuator 10 is fitted in a manner which is locked against rotation.

FIGS. 7 to 10 are described together in the following. Peculiarities of the single figures are pointed out when needed. FIG. 7 to 10 show schematic perspective views of another embodiment of an adapter 116 according to the invention.

The adapter 116 has an adapter housing 113 comprising an elongate base plate 128 with a longitudinal axis M. The base plate 128 has an essentially rectangular shape. Parallel to axis M, the base plate 128 has two co-planar side panels 129.1 and 129.2 which are perpendicular to base plate 128 and are arranged with the base plate 128 to have a u-shaped cross section in a plane perpendicular to axis M. In FIG. 7 to 9, the side panels 129.1/2 and the base plate 128 are made from one piece of sheet metal by bending up rim sections of the base plate 128 by an angle of 90 degrees.

The side panels 129.1, 129.2 have each two mounting slots 131 on their far edges from the base plate 128 for inserting corresponding mounting lugs 187 of a back plate 125 (see FIG. 10). When mounted to the side panels 129.1, 129.2, the back plate 125 is essentially co-planar with the base plate 128. Thus, the base plate 128 together with the side panels 129.1, 129.2 and the thereto mounted back plate 125 form a cuboidal shape of the housing 113 of the adapter 116 with a cavity which is open at longitudinal ends 101 and 102 of the housing 113.

At its longitudinal end 101, the base plate 128 has a u-shaped slot 140 extending in direction of longitudinal axis M such that a continuous drive shaft 124 (not shown) can be inserted with its longitudinal axis perpendicular to M in radial direction, i.e. in direction of M, into slot 140. The drive shaft 124 extends, when fully inserted into the slot 140, through the adapter housing 113. The back plate 125 has a corresponding slot 186 which essentially corresponds in shape to the slot 140 and is aligned with the slot 140 in direction perpendicular to the base plate 128.

At its bottom, the u-shaped slot 140 has a circular widening 141 with a diameter larger than a diameter of the drive shaft 124. The circular widening 141 can receive a bearing insert 135. The bearing insert 135 is essentially tubular and has a length which allows it to extend through the housing 113 in a direction perpendicular to the base plate 128. When being mounted in the adapter housing, the bearing insert 135 is arranged with its longitudinal axis P perpendicular to the base plate 128. On its outer circumference, the bearing insert 135 has a first mounting recess 137.1 at one of its longitudinal ends for receiving an inner edge of the circular widening 141 in the base plate 128. On its opposite longitudinal end the bearing insert 135 has a second mounting recess 137.2 for receiving an inner edge of a widening 186 in the back plate 125 which corresponds to the widening 141 in the base plate 128. The bearing insert 135 therefore is held in place by the base plate 128 and the back plate 125 engaging with the mounting recesses 137.1/2 of the insert 135.

The bearing insert 135 has a longitudinal opening 139 parallel to longitudinal axis P in its outer shell 143. The opening 139 has an azimutal width corresponding to a width of slot 140. When assembling the adapter 116, the bearing insert 135 is first rotated around its longitudinal axis P such that the opening 139 is directed in a direction perpendicular to M with p perpendicular to base plate 128 before insertion into the slot 140. The inner edge of slot 140 engages the recess 137.1 when bringing the bearing insert 135 into slot 140. Having positioned the bearing insert 135 in the circular widening 141 of slot 140, the bearing piece 135 is rotated such that the opening 139 is aligned and communicates with slot 140. When mounting the back plate 125 to the side panels 129.1/2, the inner edge of the slot in the back plate engages with mounting recess 137.2 of the bearing insert 135, thus securing the bearing insert 135 to the housing 113.

When attaching the adapter 116 to the drive shaft 124, the drive shaft 124 is inserted to the slot 140 and is received by the bearing insert 135. The bearing insert 135 thereby forms a bearing seat for the drive shaft 124. When fully inserted, the longitudinal axis of the drive shaft 124 is co-axially arranged with the longitudinal axis P of the tubular insert 135. Preferably, the bearing insert 135 is made from plastic having good friction properties and sufficient mechanical stability. Other materials are also possible and the person skilled in the art is well aware of materials which suit the purpose of the bearing insert 135 as described herein.

A further recess 145 in the outer shell of the bearing insert 135 between recesses 137.1 and 137.2 forms a guiding recess 145 for a drive yoke 164. The drive yoke 164 is essentially arranged inside the housing 113 and has, longitudinally centrally, a circular slot 165 with an inner radius corresponding to an outer radius of the recess 145. The recess 145 can therefore engage with the inner edge of the circular slot 165 of the yoke 164 which then is rotatably guided for rotation about the longitudinal axis P of the tubular bearing insert 135. The bearing insert 135 thus forms a bearing seat for the drive yoke 164.

The drive yoke 164 has a lug 169 which is bent approximately at a right angle. The lug 169 of the yoke 164 extends through an opening 111 in the base plate 128 where the opening 111 has an annular shape in order to allow for the above described rotation of the yoke 164 about the axis P. The opening 111 is preferentially shaped such that the pivotal range of said rotation is slightly over 90 degrees. The lug 169 is thereby located in the external space of the adapter housing 113, i.e. outside the housing 113 and is therefore easily accessible for mounting purposes (see also FIG. 9).

Attached to the lug 169, outside the housing 113, is a clamp 122 with two legs 156 with external threads which extend through corresponding openings 185 in the lug 169 of the yoke 164. A u-shaped profile 182 riveted to the lug 169 forms a seat 158 for the drive shaft 124 (see FIG. 8). The clamp 122 encompasses the drive shaft 124 which is co-axially arranged in the bearing insert 135. The clamp 122 lies outside the adapter housing 113 with the legs 156 through the openings 185 in the yoke's 164 lug 169. Two screw nuts 154 (see FIG. 8) with plain washers tighten the clamp 122 onto the drive shaft 124 which in turn is tightened against the seat 158 and the lug 169 thus forming a frictional connection between drive shaft 124 and yoke 164. FIG. 9 shows the lug 169 without attached clamp 122.

In a suchlike configuration, the drive shaft 124 is rotated about its longitudinal axis when rotating the yoke 164 in the guiding recess 145 about the axis P. The drive shaft 124 is thereby being supported by the bearing insert 135. In particular, the co-axial alignment of the longitudinal axis of the drive shaft 124 with axis P of the bearing insert 135 allows for rotation of the drive shaft 124 about its longitudinal axis without any translational movement of the base plate 128 or the adapter housing 113. The adapter 116 and/or a thereto attached actuator 110 can therefore be mounted to a support frame or structure of the actuated member in a way locked against rotation and do not have to be able to move when actuating e.g. a damper or a valve.

The yoke 164 by itself forms part of a four bar linkage with pairwise parallel bars, i.e. a linkage parallelogram 120. The linkage parallelogram 120 comprises a second yoke 162, i.e. a gearing yoke 162, essentially being arranged in parallel with the drive yoke 164. Two parallel connecting rods 166 and 168 are connected in an articulated manner to the gearing yoke 162 and to the drive yoke 164. Thus, yokes 162/164 and rods 166/168 together form the linkage parallelogram 120 for transferring a rotary movement of yoke 162 to yoke 164 and vice versa. A plane of the parallelogram 120 is essentially co-planar to the base plate 128. The parallelogram 120 is thereby essentially arranged inside the cavity formed by the adapter housing 113.

Yoke 162 is attached to a gearing input shaft 117 which in turn can be connected to a drive output of an actuator 110 (not shown). The gearing input shaft 117 is thereby arranged with its longitudinal axis O perpendicular to the base plate 128 i.e. with its longitudinal axis O parallel to the longitudinal axis of the drive shaft 124. Gearing shaft 117 and yoke 162 together are supported and held in place by a second bearing insert 119 which is arranged in an opening 121 in the base plate 128. The bearing insert 117 thereby forms a support of gearing input shaft 117 and allows for a rotation of gearing shaft 117 and thereto attached yoke 162 about the axis O. The second bearing insert 119 is also preferentially formed from plastics or other materials to ensure good friction qualities and long lifetime.

By rotationally driving the gearing shaft 117 about its axis O with the actuator 110 the yoke 162 is also rotated about axis O. A rotation of yoke 162 is transferred by the linkage rods 166 and 168 to yoke 164 in a compulsory manner, i.e. yoke 162 has to follow the movement of yoke 164 and vice versa.

The parallelogram 120 thus forming a torque transfer mechanism for transferring an input torque exerted on the gearing shaft 117 about its longitudinal axis O to an output torque on the drive shaft 124 about its longitudinal axis. The transferred torque can be used for e.g. driving a damper valve or similar.

A great advantage of the arrangement according to the invention on the one hand is a essentially failsafe operability of the torque transfer mechanism compared to known systems. On the other hand the four bar linkage offers a simpler and sturdier construction of a torque transfer mechanism than other systems involving e.g. toothed wheels. A four bar linkage does not need to be manufactured with high accuracy, and is therefore cheap, while still performing well. Torque transfer mechanisms involving toothed wheels require higher manufacturing accuracy and have also disadvantages regarding a failsafe operation. Toothed wheels have to be fairly clean in order for the teeth to mesh properly. Blocking of only one tooth can jam the whole transfer mechanism. Pollution thus can lead to failure resulting in inhibition of the torque transfer function. In particular regarding possible emergency situations involving fires, blocking of air vents or similar could lead to failure with potentially fatal consequences. The invention instead is practically pollution resistant in that a four bar linkage performs well even when heavily polluted with e.g. soot, dust and/or ashes. Moreover, the four bar linkage is contained in the described adapter housing which offers further protection from pollution. Pollution safe torque transfer mechanism is in particular relevant for in-duct mounting configurations. In addition, a torque transfer mechanism based on a linkage parallelogram offers wider freedom in designing the system than offered by e.g. known systems with toothed wheels. Toothed wheels require a rather accurate adjustment of distances between the hub-axes of the toothed wheels in order to provide for proper meshing of the teeth. Compared to linkage systems that are freely floating i.e. comprising a linkage rod linking a crank-arm on the actuator output hub with a drive shaft mounted crank-arm, the system according to the invention offers a modular unit which comprises all necessary components and therefore offers a well controllable and simple to mount solution. No particular adjustment of distances between actuator and drive shaft or similar have to be observed when mounting the system. The adapter itself forms a gauge.

The construction as a linkage parallelogram also has the advantage of stabilizing the output yoke i.e. the drive yoke as compared e.g. to said crankarms of the prior art. The clamp for connection to the drive shaft can therefore be rotatably held in place without further attachment of the drive yoke to the housing (besides the guidance in the guiding recess of the bearing insert). The parallel connecting rods of the four bar linkage ensures that the drive yoke cannot slip out of the guiding recess of the bearing insert and remains engaged therein.

FIGS. 7 and 8 also show an extension of the adapter 116 in form of a mounting bracket 178. The mounting bracket 178 is detachably attached to an outside surface 180 of the base plate 128 and allows for mounting the actuator 110 to the adapter 116. The mounting bracket 178 extends in direction of M beyond the longitudinal end 102 of the housing 113 and has at a far longitudinal end a pinion or bolt 136 for insertion in a corresponding longitudinal central slot of the actuator 110 (compare slot 34 of e.g. FIG. 5). By attaching an output gearing shaft of the actuator 110 to the gearing input shaft 117 of the adapter 116 and inserting the pinion 136 into the central slot of the actuator 110, the actuator 110 is secured to the adapter 116 and locked against rotational or translational movement (in contrast to an actuator according to the above mentioned U.S. Pat. No. 7,025,328). In order to allow for different types of actuators being mountable to the adapter 116, the bracket 178 can be attached in a plurality of position where the positions differ by the distance of the pinion 136 from the longitudinal axis O of the gearing input shaft 117. The base plate 128 has for this purpose a plurality of mounting openings 184 for e.g. receiving bolts that attach the bracket to the base plate 128 (see FIG. 9)

The adapter according to the invention therefore offers a unit for simple attachment of an actuator to a drive shaft. In particular, the adapter provides for a a self contained unit, which does not have to be assembled in place but rather can be prepared as needed prior to mounting it to the drive shaft. Moreover, the adapter can be mounted independently from the mounting of the actuator. No detached parts of the adapter have to be separately attached to the actuator or its housing, respectively. All parts of the adapter are attached to the housing or the base plate of the adapter and no parts have to be attached to a housing of the actuator. The base plate or the adapter housing with base plate thus allow for a mechanical design of the adapter that is self-contained and can be mounted in a modular fashion, entirely independent form the mounting of the actuator. In particular, the adapter of the invention allows for mounting an actuator to a drive shaft of e.g. a damper or valve which involves e.g. the following steps in the following order:

1. mounting the adapter to a drive shaft;

2. securing the adapter to a frame or support structure of the actuated member;

3. attaching the actuator to the adapter;

4. connecting the actuator to electricity/control units etc.;

Prior to mounting the adapter to a drive shaft, the adapter can e.g. be prepared as needed to receive the most suitable or wished actuator (via the mounting bracket). A particular advantage in this mounting procedure lies in the fact that the mounting of the mechanics can be well separated from electrical installation. The according procedures are usually done by different persons skilled in their arts: the mechanical installation of steps 1 and 2 is done by an installer and the electrical installation of steps 3 and 4 by an electrician. By allowing separating the different areas of expertise of the full installation procedure, the different installation processes can be sequentially performed without any interference. With other words, the adapter can be used as mounting bracket for the actuator. The adapter thereby being attached to the supporting frame or structure of the member to be actuated, thus forms a mounting bracket for the actuator.

1. Actuator and adapter, the actuator comprising
an electric motor,
a gearing output shaft
and a highly reduced gearing for transmitting a torque of the electric motor to said gearing output shaft
wherein the adapter is designed to transfer a torque from the gearing output shaft to a drive shaft of an actuated member,
said actuated member being at least one flap or at least one valve for controlling a gas or fluid volume flow, in particular in the sector of heating/ventilation/air-conditioning (HVAC), fire and area protection,
wherein
the adapter is configured to be fitted to a continuous drive shaft in a direction which is radially oriented with respect to the drive shaft
the adapter is further configured to form a releasable frictional and/or positive connection to said drive shaft and
the adapter is configured to be mounted on a frame or support of the actuated member in a manner which is locked against rotation.

2. Actuator and adapter according to claim 1, characterized in that the adapter has at least one end insertion slot for the drive shaft, which slot is substantially U-shaped or semicircular.

3. Actuator and adapter according to claim 1 or 2, characterized in that the gearing output shaft of the actuator is a pipe segment-shaped gearing output shaft, with internal teeth, which, after mounting of the actuator, are in positive engagement with external teeth of a gearing shaft of the adapter.

4. Actuator and adapter according to claim 1, characterized in that the actuator and/or the adapter is fixed, to form the frictional and/or positive connection with the drive shaft, by a screw connection or by a quick release fastener, to the frame or a support of the actuated member.

5. Actuator and adapter according to claim 1, characterized in that the adapter comprises a parallelogram which is fitted to a base plate and comprises a gearing yoke which can be actuated by the actuator, a drive yoke for the drive shaft and two parallel connecting rods connected in an articulated manner to the ends of the two yokes, the gearing yoke being connected to the gearing output shaft and the drive yoke to the drive shaft in a frictional and/or positive manner.

6. Actuator and adapter according to claim 5, characterized in that the gearing input shaft of the adapter is coupled to the gearing yoke of the parallelogram where the gearing yoke is rotatably guided in relation to the base plate and the gearing input shaft of the adapter engages the output gearing shaft of the actuator with a frictional or positive connection.

7. Actuator and adapter according to claim 5, characterized in that the drive yoke comprises a shoulder which is bent at least once at a right angle in the longitudinal direction thereof and which is penetrated by the legs of a clamp fixing the drive shaft with a frictional and partially positive connection, the legs thereof being fastened with screw nuts.

8. Actuator and adapter according to claim 1, characterized in that the actuator is also fitted in a manner locked against rotation, preferably screwed, to the adapter.

9. Actuator and adapter according to claim 8, characterized in that the actuator is fitted to an extension of the base plate of the adapter.

10. Actuator and adapter according to claim 5, characterized in that the connecting rods of the parallelogram extend in the longitudinal direction L of the base plate or are angled at an angle (α) up to about 90° to one side or the other.

11. Adapter for transmitting a torque from a separate actuator to a drive shaft of at least one flap or at least one valve for controlling a gas or fluid volume flow, in particular in the sector of heating/ventilation/air-conditioning (HVAC), fire and area protection,
wherein
the adapter is configured to be fitted to a continuous drive shaft in a direction which is radially oriented with respect to the drive shaft
the adapter is further configured to form a releasable frictional and/or positive connection to said drive shaft and
the adapter is configured to be mounted on a frame or support of the actuated member in a manner which is locked against rotation.

12. Adapter according to claim 11, characterized in that it has at least one end an insertion slot for the drive shaft, which slot is substantially U-shaped or semicircular.

13. Adapter according to one of claims 11 or 12, characterized in that it comprises a removable bearing insert arranged in the insertion slot forming a bearing seat for the drive shaft.

14. Adapter according to claim 11, characterized in that it comprises a torque transfer mechanism in form of a linkage parallelogram which is fitted to a base plate and comprises a gearing yoke which can be actuated by the actuator, a drive yoke for the drive shaft and two parallel connecting rods connected in an articulated manner to the ends of the two yokes, the gearing yoke being connected to a gearing input shaft and the drive yoke being connected to the drive shaft in a frictional and/or positive manner.

15. Adapter according to claim 14, characterized in that the bearing insert forms a bearing seat for the drive yoke.

16. Method for mounting an actuator for an actuated member comprising the steps of
mounting the adapter to a drive shaft;
securing the adapter to a frame or support structure of the actuated member;
attaching the actuator to the adapter;
connecting the actuator to electricity/control units etc.;
wherein the adapter serves as a mounting bracket for the actuator and the adapter is fixedly mounted so as to be locked against rotation.
